(19) United States
(12) Patent Application Publication
(10) Pub. No.: US 2024/0249149 A1
(43) Pub. Date: Jul. 25, 2024

(54) WARM UP TABLE FOR FAST REINFORCEMENT LEARNING MODEL TRAINING

(71) Applicant: Dell Products L.P., Round Rock, TX (US)

(72) Inventors: Eduardo Vera Sousa, Niterói (BR); João Victor Pinto, Rio de Janeiro (BR); Julia Drummond Noce, Rio de Janeiro (BR); Micael Veríssimo de Araújo, Rio de Janeiro (BR); Yanexis Pupo Toledo, Rio de Janeiro (BR)

(21) Appl. No.: 18/157,168

(22) Filed: Jan. 20, 2023

(51) Int. Cl. G06N 3/08

(52) U.S. Cl. CPC G06N 3/092

(57) ABSTRACT

Warm up or look up tables are generated for training reinforcement learning models. Rather than wait for a metric, such as execution times, that are required to determine a reward, previously generated warm up tables that include a probability distribution of the metric are used such that the reward can be determined without waiting for a workload to finish executing. The ability to determine the reward more quickly can shorten training times and help compensate for the exploration/exploitation trade-off experienced in training reinforcement learning models. The warm up table considers averages of a relevant metric and standard deviation of different workload instance-device associations such that the metric can be sampled from the probability distribution.

### FIELD OF THE INVENTION

Embodiments of the present invention generally relate to allocating workloads in a computing system or environment. More particularly, at least some embodiments of the invention relate to systems, hardware, software, computer-readable media, and methods for training models configured to allocate workloads in a computing system.

### BACKGROUND

Cloud computing has several advantages, which include pay-per-use computation from the customer's perspective and resource sharing from the provider's perspective. Using virtualization, it is possible to abstract a pool of computing devices to offer computing resources to users (e.g., consumers or customers) that are tailored to the needs of the users. Using various abstractions such as containers and virtual machines, it is possible to offer computation services without the user knowing what infrastructure is executing the user's code. These services may include Platform as a Service (PaaS) and Function as a Service (FaaS) paradigms.

In these paradigms, the QoS expected by the user may be expressed through SLAs. SLAs often reflect expectations such as response time, execution time, uptime percentage, and/or other metrics. Providers try to ensure that they comply with the SLAs in order to avoid contractual fines and to preserve their reputation as an infrastructure provider.

Providers are thus faced with the problem of ensuring that they comply with the contractual agreements (e.g., SLAs) to which they have agreed. Providers may take different approaches to ensure they comply with their contractual agreements. In one example, a provider may dedicate a static amount of resources to each user. This presents a couple of problems. First, it is problematic to assume that an application is bounded by one particular resource. Some applications may have an IO (Input/Output) intensive phase followed by a compute-intensive phase. Dedicating some amount of static resources to each user may result in inefficiencies and idle resources. Further, it is possible that the initial allocation of resources may be under-estimated or over-estimated.

Allocating excessive resources may also adversely impact the provider. From the perspective of a single workload, the provider may perform the workload and easily comply with the relevant SLAs. However, the number of users that can be served by the provider is effectively reduced because the amount of spare resources dictates how many workloads can be performed in parallel while still respecting the SLAs. As a result, allocating excessive resources to a single workload impacts the overall efficiency and may limit the number of workloads the provider can accommodate.

While SLAs are often determined in advance of performing a workload, the execution environment is more dynamic. New workloads may compete for computing resources, and this may lead to unplanned demand, which may disrupt the original workload planning because of a greater need to share resources, workload priorities, and overhead associated with context switching.

The challenge facing providers is to provide services to their users in a manner that respects SLAs while minimizing resource usage. Stated differently, providers are faced with the challenge of efficiently using their resources to maximize the number of users.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIG. 1 discloses aspects of allocating workloads in a computing system or in computing resources;

FIG. 2 discloses aspects of reinforcement learning models and operations;

FIG. 3 discloses aspects of a reward used in reinforcement learning;

FIG. 4 discloses aspects of training a reinforcement learning model including generating a warm up table storing at least one metric;

FIG. 5 discloses aspects of pseudocode for generating a warm up table;

FIG. 6 discloses aspects of probability distributions for execution times;

FIG. 7 discloses aspects of training a model such as a reinforcement learning model;

FIG. 8 discloses aspects of pseudocode for training a reinforcement learning model; and

FIG. 9 discloses aspects of a computing device, system, or entity.

### DETAILED DESCRIPTION OF SOME EXAMPLE EMBODIMENTS

Embodiments of the present invention generally relate to training models, such as reinforcement learning models. More particularly, at least some embodiments of the invention relate to systems, hardware, software, computer-readable media, and methods for training models in the context of applications such as, but not limited to, workload allocation in computing environment.

Example embodiments relate to training scenarios where a reward function is dependent on a computation or value that is not acquired immediately. This problem is addressed by generating a probability distribution for those computations. This allows the training operations to be performed more quickly because the information needed to generate or determine rewards can be determined from or sampled from the probability distribution. The conventional need to wait for the computation metrics, which time may be significant, is avoided. Thus, the time required to train a model such as a reinforcement model is reduced.

Embodiments of the invention more specifically relate to and are described in the context of training models to allocate workloads (e.g., recommend allocation actions) in a computing environment. Embodiments of the invention, however, may be implemented in other applications. Embodiments of the invention further relate to reducing the time required to train a model and compensate for the exploration/exploitation trade-off experienced when randomly exploring different unknown actions/states.

Models such as reinforcement learning models can be trained to allocate workloads (e.g., place, migrate, remove workloads) to resources as required in order to comply with SLAs and to efficiently use resources. In one example, allocating workloads is achieved by placing workloads in specific resources, which may include migrating the workloads from one location to another location. Workloads are allocated such that SLAs are respected, to cure SLA violations, and/or such that the resources of the provider are used beneficially from the provider's perspective. One advantage of embodiments of the invention is to allow a provider to maximize use of their resources.

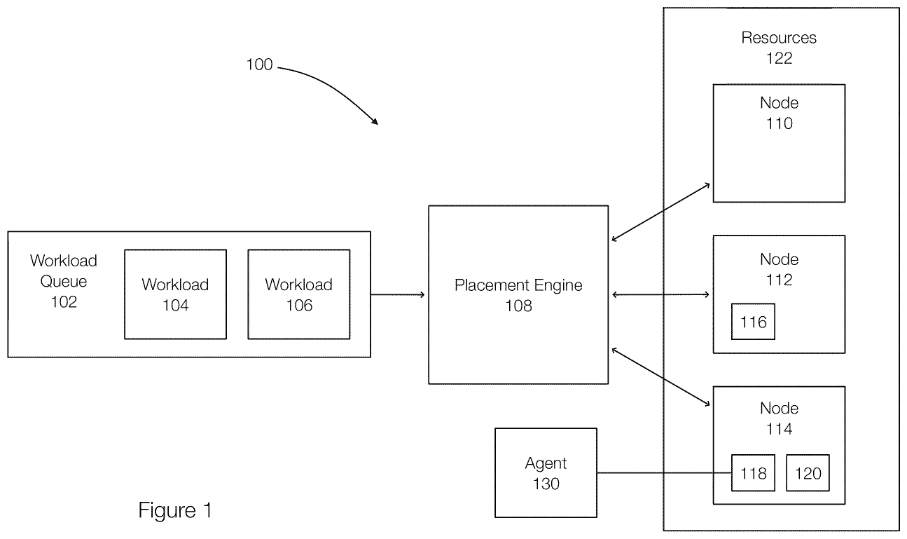

Prior to discussing aspects of training a reinforcement learning model, a description of an operating reinforcement learning model is described. FIG. 1 discloses aspects of reinforcement learning based workload allocation in a computing environment. A system 100 (e.g., a datacenter or other computing environment) may include resources 122. The resources 122, alternatively, may represent geographically distributed resources (e.g., one or more edge systems, one or more datacenters). The resources 122 may include nodes, which are represented by the nodes 110, 112, and 114. Nodes may each include a computing device or system with processors, memory, network hardware, and the like. The nodes 110, 112, and 114 may include physical machines, virtual machines, containers, and the like. Workloads are typically assigned to computers, containers, or virtual machines operating or included in the nodes 110, 112, and 114.

The resources 122 of the system 100 may be used to execute or perform workloads. In other words, the system 100 allocates the workloads to or in the resources 122 such that the workloads are executed in the resources 122. Allocating a resource may include placing a workload at a node (e.g., at a virtual machine) and/or migrating a workload from one node to another node or from one virtual machine to another virtual machine.

The following discussion assumes that workloads are performed or executed by virtual machines and that each of the nodes 110, 112, and 114 may support one or more virtual machines. Further, each virtual machine may perform or execute one or more workloads of one or more types. Example workload types include, but are not limited to, central processing unit (CPU) bound workloads and graphics processing unit (GPU) bound workloads.

The system 100 may include or have access to a workload queue 102 that stores workloads, represented by the workloads 104 and 106. When a user or application submits a workload, the workload may be stored in the workload queue 102 and then allocated in the resources 122.

The system 100 may also include a placement engine 108, which may also operate on a node or server. The placement engine 108 may include a machine learning model. In one embodiment, the placement engine 108 may include a reinforcement learning model configured to generate allocation recommendations or actions for workloads executing in the resources 122. The allocation recommendations may have different forms. For example, the allocation recommendations may be in the form of a reward if a certain action is performed. The action associated with the highest reward available and/or output by the placement engine 108 is typically performed.

FIG. 1 illustrates that a workload 116 has been placed at the node 112 and that workloads 118 and 120 have been placed at the node 114. More specifically, the workload 116 may be performed by a virtual machine instantiated on the node 112 and the workloads 118 and 120 may be performed by one or more virtual machines instantiated on the node 114. These workloads 116, 118, and 120 were placed, in one example, by an agent based on recommendations of the placement engine 108. In one example, the agent and workload are the same.

The placement engine 108 may include a trained reinforcement learning model that receives, as input, the state of the resources 122 as well as a reward associated with the execution of the workloads 116, 118, and 120 to generate new allocation recommendations. This may result in the migration of one or more of the workloads 116, 118, and 120 to different virtual machines or to a different portion of the resources 122.

The placement engine 108, once trained, thus makes allocation decisions or allocation recommendations. Allocation decisions or recommendations may include placing a new workload at a node or a virtual machine, moving or migrating a workload from a current node or virtual machine to a different node or virtual machine, and keeping a workload at the same node or virtual machine.

Each of the workloads is associated with an agent in on example. An agent, by way of example, may be a component or engine that operates in a computing environment to perform actions, communication, or the like. An agent may thus generate goals, perform actions, sense the environment, determine status of a computing system, learn, or the like.

FIG. 1 illustrates an agent 130 associated with a workload 118. In one embodiment, each of the workloads 116, 118, 120 executing in the resources 122 is associated with a different agent. At the same time, all of the agents in the system 100 use the same placement engine 108. This allows swarm behavior for the agents where each of the agents is associated with a different workload while using the same placement engine 108. As previously stated, the agent/workload may be the same.

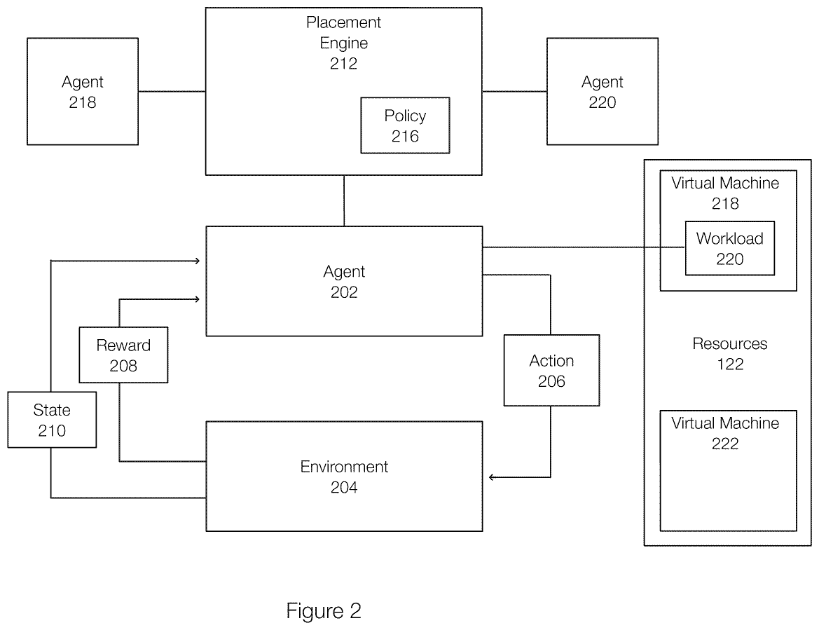

FIG. 2 discloses aspects of placing workloads using a reinforcement learning model. In FIG. 2, an agent 202 may be associated with a workload 220 being executed by a virtual machine 218, which may be part of the resources 122. The agent 202 may perform an action 206 (e.g., an allocation+action) with regard to the workload 220. The action 206 may include leaving the workload 220 at the virtual machine 218 or moving/migrating the workload 220 to the virtual machine 222.

The action 206 is thus executed in the environment 204, which includes the resources 122 or more specifically the virtual machines 218 and 222. After execution or during execution of the workload 220, the state 210 and/or a reward 208 may be determined and returned to the agent 202 and/or to the placement engine 212.

In one example embodiment, the reward 208 may be a value that represents the execution of the workload 220 relative to an SLA or an SLA metric. For example, the reward may represent a relationship between the response time (rt) of the workload and the response time specified in the SLA.

An example reward function may be defined as follows:

$$f ( Δ , {σ}_{L} , {σ}_{R} ) = \frac{- {( Δ )}^{2}}{{e}^{2 {σ}_{L}^{2}}} if Δ > 1 , otherwise \frac{- {( Δ )}^{2}}{{e}^{2 {σ}_{L}^{2}} - 1} .$$

In one example embodiment, A is a difference between the SLA and the response time. In one example, σ_{L},σ_{R} define, respectively, how fast the left and right portion of the curve decays.

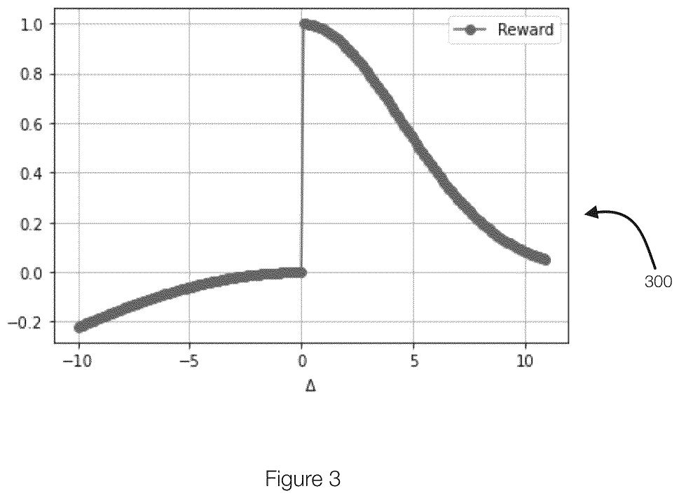

FIG. 3 discloses aspects of a reward curve. More specifically, the curve 300 is an example of a reward curve where σ_{L}=2 and σ_{R}=0.75. In this example, there are several possibilities for the value of Δ:
1) Δ>0→SLA>rt: In this case, there is a positive gap between the SLA and the value of the response time (rt). This indicates that resources are being wasted and should provide a positive reward.
2) Δ<0→SLA<rt: In this case, there is a negative gap between the SLA and the response time. This indicates an SLA violation and should provide a negative reward. 3) Δ=0→SLA=rt: In this case, there is no gap between the SLA and the response time. This indicates that the workload fits perfectly with the infrastructure and a maximum reward should be provided.

In one example embodiment, the state 210 may include or represent one or more of resource usage per virtual machine, resource usage per workload, state of each workload, time to completion for each workload, resources available/used, or the like or combinations thereof. The state 210 may be formed as a type or style of one hot encoding that allows the state of all resources (e.g., all virtual machines/nodes in the resources 122) to be included in the one hot encoding style. In one example, the one-hot encoding includes floating point values to represent the state 210. The state 210 may also represent resources (e.g., idle virtual machines) that are not being used. The state 210 allows all agents to have insight and understanding into the infrastructure and state of all resources. In other words, each of the agents can see the environment of the workload as well as the other workload environments in the system. As previously stated, however, all of the agents share or use the same placement engine 212 in one example.

In one example, the state 210 of the environment 204 and the reward 208 are input into the placement engine 212 (directly or by the agent 202 as illustrated in FIG. 2). The state 210 may include the state of each node or virtual machine included in the resources 122. This information can be represented in a one hot encoding style. In this example, the reward 208 reflects the actual performance (rt) at the virtual machine of the workload 220. If using response time (rt) as a metric, the reward reflects the relationship between the actual response time and the SLA response time.

The placement engine 212 may generate a new recommended action for the agent 202 to perform for the workload 220. This allows the agent 202 to continually adapt to changes (e.g., SLA compliance/non-compliance) at the resources 122 and perform placement actions that are best for the workload 220 and/or for the provider to comply with SLA requirements, efficiently use the resources 122, or the like.

The placement engine 212 may also have a policy 216 that may impact the placement recommendations. The policy, for example, may be to place workloads using a minimum number of virtual machines, to perform load balancing across all virtual machines, or to place workloads using reinforced learning. These policies can be modified or combined. For example, the policy may be to place workloads using reinforced learning with some emphasis towards using a minimum number of virtual machines or with emphasis toward load balancing. Other policies may be implemented.

The output of the placement engine 212, may depend on how many actions are available or defined. If a first action is to keep the workload where the workload is currently operating and the second action is to move the workload to a different node, the output of the placement engine may include two anticipated rewards. One of the rewards corresponds to performing the first action and the other reward corresponds to performing the second action. The action selected by the agent 202 will likely be the action that is expected to give the highest reward. As illustrated in FIG. 2, multiple agents 218, 220, and 202 are using the same placement engine 212. In one example, because the resources 122 may include multiple virtual machines, an expected reward may be generated for migrating the workload to one of those virtual machines.

The placement engine 212, prior to use, may be trained. When training the placement engine 212, workloads may be moved randomly within the resources. At each node, a reward as generated or determined. These rewards, along with the state, can be used to train the placement engine 212. Over time, the placement becomes less random and begins to rely on the output of the placement engine 212 until training is complete.

Thus, the placement engine 212, by receiving the reward 208 and state 210 during training, which may include multiple migrations some of which may be random, can implement reinforcement learning training. Conventionally, reinforcement learning may rely on a Q-table. Embodiments of the invention, however, may provide deep learning reinforcement learning. More specifically, the placement engine 212 may include a neural network that allows the experiences of the agents, along with random migrations, to train the placement engine 212. One advantage of the placement engine 212 is that the placement actions or recommendations can be mapped to a much larger number of states compared to a conventional Q-table, which is essentially a lookup table, and that the mapping can be learned.

In opposition to SLAs, which are set before the execution of a job, the execution environment is often dynamic. As previously stated, new workloads may compete for resources and unplanned demand peaks might occur, which might disrupt the original workload planning due to tasks with higher priorities, greater need to share the environment, and overheads because of context switching. Service providers always aim to provide services to their customers respecting SLAs and minimizing resource usage.

In one embodiment, metrics related to SLAs may be collected. For example, response times may be collected as historical data from workload executions. These metrics can be used to generate a probability distribution function that can be stored in a warm up table. This allows metrics to be estimated when required. Although it may be necessary to complete execution of the workload to collect historical data, this task is performed only k times, where k is the number of samples needed to generate the probability distribution instead of n-times, where n is the number of memories needed by a reinforcement learning model. In other words, k<<n.

In one example, a look up or warm up table that stores the probability distribution of metrics that agents use to determine rewards is generated offline or prior to training. During a training scenario or operation, agents to not need to wait for the calculations to be generated. IN other words, agents to not need to wait for the workload to be executed. Rather, the table can be accessed for the relevant information. This reduces the time required to train the reinforcement learning algorithm and allows the reinforcement learning algorithm converge more quickly. In addition, embodiments of the invention help compensate for the exploration/exploitation trade-off, a dilemma that reinforcement learning algorithms often face when randomly exploring different unknown actions-states. Because the table considers the averages and the standard deviation of different associations between workload instances and devices or nodes, embodiments of the invention advantageously consider broader situations than those that are normally considered by reinforcement learning agents in each training cycle.

More specifically, conventional training scenarios require the agent to wait until a workload has executed multiple times, depending on the training strategy. A larger space state can lead to longer and potentially unfeasible training times. By generating the warm up table, agents are not required to wait for the workload to execute but can access the distribution represented in the warm up table.

In a Multi-Agent Reinforcement Learning (MARL) method workload allocation training process, considering an environment with multiple devices with different resources (GPUs, number of cores, etc.), one goal is to define workload-device (node) association such that SLA requirements can be satisfied.

During a conventional training process, agents (workload instances) perform an action (they are allocated to nodes in the resources), where each node is or represents a state of the environment. Each action receives a reward that depends on the response time in each state. Notes on these actions include allocation information for each workload. This training cycle corresponds to an experiment (putting workload instances on devices, i.e., orchestration). For each training cycle, it is necessary to wait until the execution of the workload instances on the devices (the execution of the agent actions in that cycle) to be able to collect the information regarding the execution times that will later be used to determine the reward and evaluate the experience acquired in that cycle. To train this method, many of these experiments are necessary due to the different possible combinations between workload instances-device associations, which allow, over time, to create a robust reinforcement learning model with good rewards.

To avoid waiting for the execution of the workloads in the middle of the training cycle, embodiments of the invention provide a warm up table that facilitates the rapid training of the reinforcement learning model. As previously stated, the execution times are collected for some workload instances-device associations (e.g., k execution times) offline. These collected associations require a few runs to have enough samples to describe a probability distribution. But despite being a lengthy process, once the information is collected and stored in the warm up table, the warm up table facilitates the learning of the agents and ensures a fast convergence of the reinforcement learning model for allocating loads in heterogeneous devices.

Embodiments of the invention can be used to address other application fronts or to help other value-based reinforcement learning applications, such as DQN, policy-gradient or any model-based methods, where the reward function is dependent on some computation not acquired immediately.

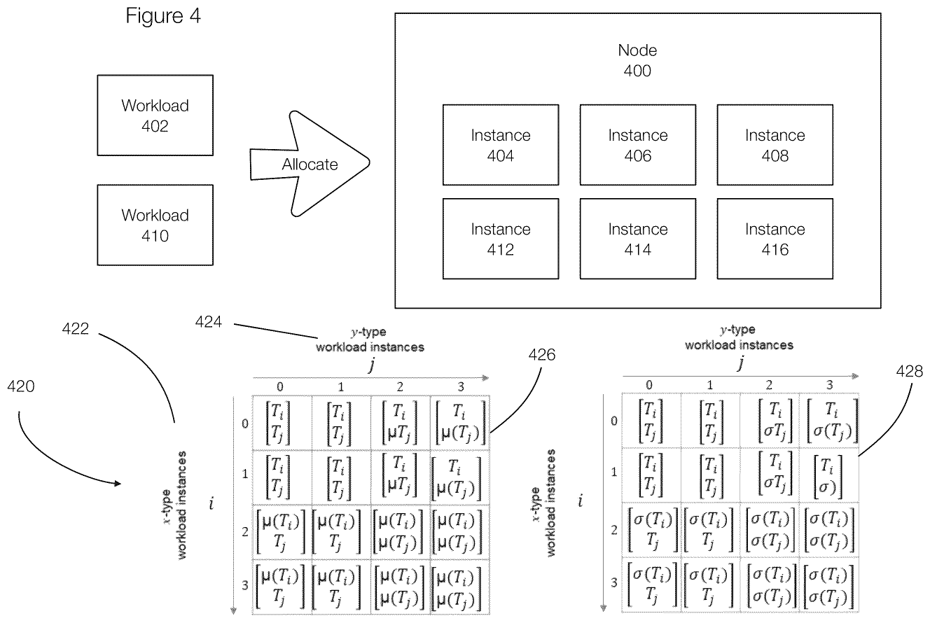

FIG. 4 discloses aspects of generating a warm up table that can be used in training a machine learning model such as a reinforcement learning model. FIG. 4 illustrates workloads 402 and 410. The workload 402 is a type x workload (e.g., CPU bound) and the workload 410 is a type y workload (e.g., GPU bound). FIG. 4 illustrates a node 400 that may be configured to execute instances of the workloads 402 and 410.

For example purposes, up to three instances of each of the workloads 402 and 410 may be instantiated or executed on the node 400. More specifically, during an offline stage, various metrics such as execution time or response time or the like may be collected. This type of data is generated or collected in order to generate a table 420, which is an example of a warm up table for reinforcement learning operations.

When generating the table 420, metrics for various combinations of workload instances may be collected. In this example, the workload instances 404, 406, and 408 of the workload 402 are of type x and the workload instances 412, 414, and 416 of the workload 410 are of type y.

The table 420 represents the various combinations of workload instances that may be executed on the node 400. The table is a rank 3 tensor with the form (i, j, t), where the first two dimensions represent the combination of i,j workload instances of t types of workloads. The two slices of the last dimensions present the samples of each workload type.

In this example, the table 420 includes two tensors for the node 400. The first tensor 426 contains information on the averages (average execution times) and the second tensor 428 includes information on the standard deviations. In the tensors 426 and 428, Tᵢ corresponds to the execution time of workload instance type x and Tⱼ corresponds to the execution time of workload instances of type y. The table 420 thus represents a probability distribution of runtimes of different instances of both workload types. In one example, in order to avoid capturing outlier data on the execution times, Tᵢ and Tⱼ are the mean times of 100 workload runs in one example.

A table 420 may be generated for each node in the learning environment. The table 420 be expanded to multiple nodes as required. Even though the offline computation time is increased as it is necessary to measure the execution times in this example, the time spent exploring by agents when training the reinforcement learning model is decreased.

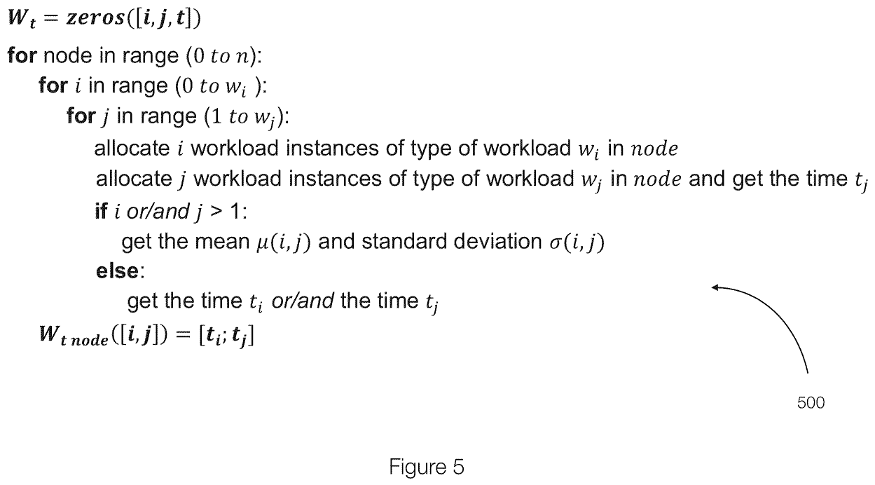

FIG. 5 discloses aspects of computing a warm table. The pseudocode 500 illustrates that a warm up table, which may include two tensors, may be generated for each of n nodes. Further, the warm up table may account for multiple combinations of 0 to i instances of a first workload type in combination with 0 to j instances of a second workload type. The pseudocode 500 can be adapted to account for additional workload types.

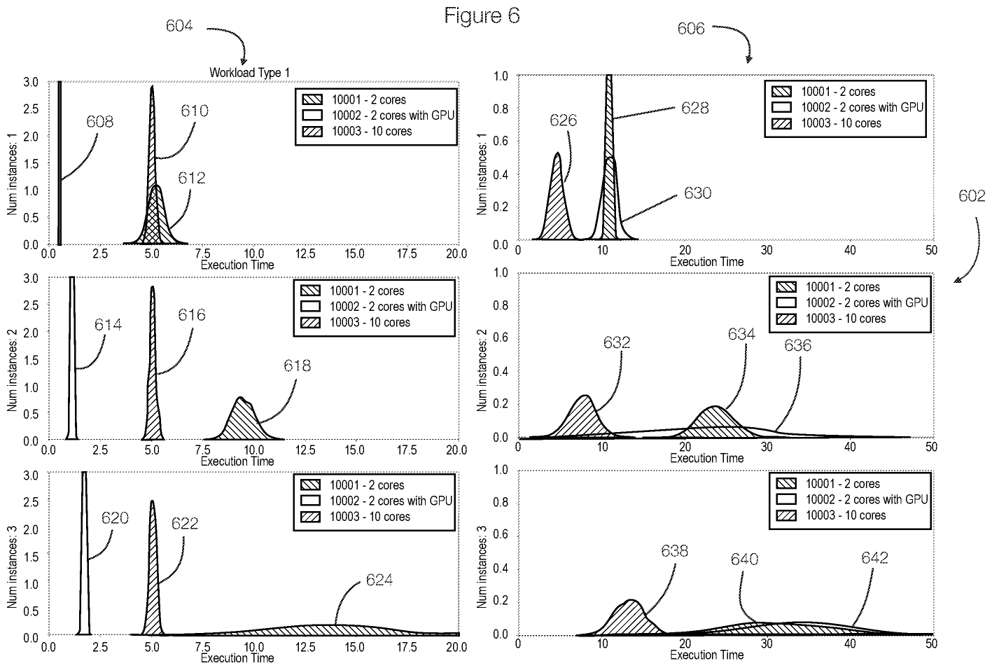

FIG. 6 discloses aspects of probability distributions when workload instances are allocated in different devices or nodes. The distributions 602 include distributions 604 in a first column 604 for 1, 2, and 3 instances of a first workload type and distributions 606 in a second column for 1, 2, and 3 instances of a second workload type. The first workload type is GPU bounded and the second workload type is CPU bounded. In this example, the distributions do not include distributions where both workload types are operating on the same device or node. Further, the distributions 602 are illustrated for 3 nodes 10001 (2 cores), 10002 (2 cores with GPU), and 10003 (10 cores).

The distributions 608, 614, 620, 630, 636, and 642 correspond to the node 10002, the distributions 610, 616, 622, 626, 632, and 638 correspond to the node 10003, and the distributions 612, 618, 624, 628, 634, and 640 correspond to the node 10001.

As illustrated in the distributions, the number of instances on a given node impacts the execution time. The node 10002, which includes GPU, has fast execution times for the first workload type, which is GPU bounded. Larger variations are shown in execution times for nodes that do not have GPUs.

For example, the first workload type in the column 604 has fast execution times on the node 10002. However, larger variations in execution times are illustrated for the nodes 10001 and 1003, which do not have GPUs. This suggests that the instances share CPU resources and the context change leads to higher execution times.

These distributions, assuming Gaussian distributions described by the captured mean and standard deviation, can considerably reduce the training time by sorting a random value from these distributions during training. In one experiment, with three heterogenous nodes and up to four instances (two of the first workload type and two of the second workload type), the training time of the DQN (Deep Q-Network) or reinforcement learning algorithm was reduced from a week to less than 1 hour.

As previously stated conventional training operations required accessing the dynamic allocation of workloads in an infrastructure in order to measure the execution time for each workload instance in the various nodes. This generates a cost in terms of times and further indicates that the training operation is waiting for the execution of the workloads to finish in order to determine the reward for the experience. This is repeated for each training cycle. Embodiments of the invention avoid this problem using the warm up table.

In one example, a multi agent reinforcement learning method or model is being trained in an environment where the reward function depends at least on the execution times of l instances of T types of workloads. Embodiments of the invention generate a warm up table as described herein. Further, the warm up table can be generated offline by measuring execution values k times, which is the number of samples needed to generate the probability distribution. Thus, although the workload executions are performed to completion k times, k is smaller than the n times that would be performed by conventional reinforcement learning methods during training operations.

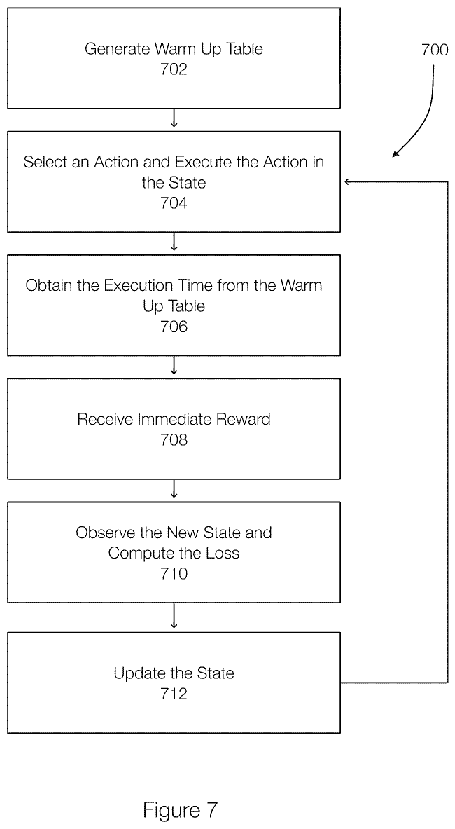

FIG. 7 discloses aspects of training a reinforcement learning model using a warm up table. The method 700 may assume that the warm up table has been generated 702. The training aspects of the method 700 may be performed iteratively (e.g., n times). Thus, once the warm up table is generated, the training operation or method may begin. In one example, an action is selected and executed 704 in the state. For example, a placement engine may recommend an allocation for a workload in a computing environment.

The execution time is then obtained 706 from the probability distributions in the warm up tables. Because the training method 700 does not need to wait for the workloads to execute, the reward is immediately received 708 or determined. Next, the new state is observed 710 and the loss is computed 710. The states are updated 712 and the next iterations is performed starting by selecting an action and executing the action in the state.

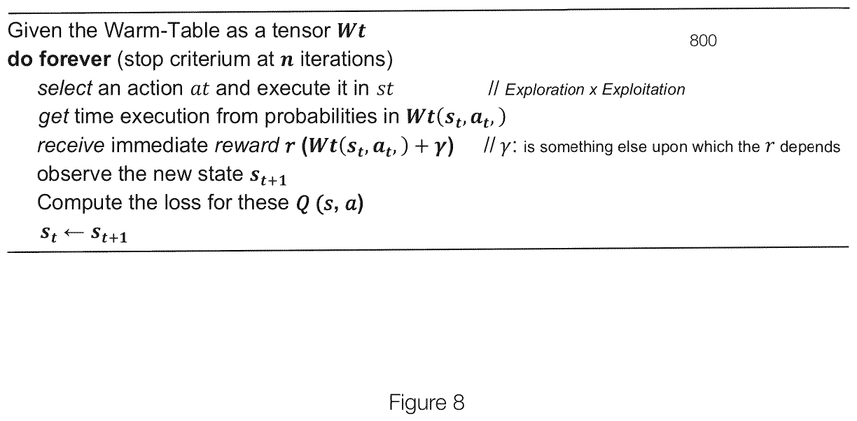

FIG. 8 discloses aspects of pseudocode 800 for a warm up table assisted reinforcement learning training operation.

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, machine learning operations, reinforcement learning operation reinforcement learning training operations, table/tensor generation operations, and the like. More generally, the scope of the invention embraces any operating environment in which the disclosed concepts may be useful.

New and/or modified data collected and/or generated in connection with some embodiments, may be stored in an environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to perform operations initiated by one or more clients or other elements of the operating environment.

Example cloud computing environments, which may or may not be public, include storage environments that may provide functionality for one or more clients. Another example of a cloud computing environment is one in which processing, machine learning, and other, services may be performed on behalf of one or more clients. Some example cloud computing environments in connection with which embodiments of the invention may be employed include, but are not limited to, Microsoft Azure, Amazon AWS, Dell EMC Cloud Storage Services, and Google Cloud. More generally however, the scope of the invention is not limited to employment of any particular type or implementation of cloud computing environment.

In addition to the cloud environment, the operating environment may also include one or more clients that are capable of collecting, modifying, and creating, data. As such, a particular client may employ, or otherwise be associated with, one or more instances of each of one or more applications that perform such operations with respect to data. Such clients may comprise physical machines, containers, or virtual machines (VMs).

Particularly, devices in the operating environment may take the form of software, physical machines, containers, or VMs, or any combination of these, though no particular device implementation or configuration is required for any embodiment. Similarly, data protection system components such as databases, storage servers, storage volumes (LUNs), storage disks, for example, may likewise take the form of software, physical machines, containers, or virtual machines (VMs), though no particular component implementation is required for any embodiment. Example embodiments of the invention are applicable to any system capable of storing and handling various types of objects, in analog, digital, or other form.

It is noted with respect to the disclosed methods, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments of the invention. These are presented only by way of example and are not intended to limit the scope of the invention in any way.

Embodiment 1. A method comprising: generating warm up tables that include probability distributions for time required to execute workload at nodes in a computing environment, and training a reinforcement learning model using the warm up tables, wherein execution times required to determine rewards for actions performed in the computing environment are determined from the warm up tables.

Embodiment 2. The method of embodiment 1, further comprising generating execution times for workloads prior to training the reinforcement learning.

Embodiment 3. The method of embodiment 1 and/or 2, further comprising generating execution times for different types of workloads.

Embodiment 4. The method of embodiment 1, 2, and/or 3, further comprising generating execution times for one or more workloads of one or more workload types.

Embodiment 5. The method of embodiment 1, 2, 3, and/or 4, further comprising generating a first tensor and a second tensor for each of the warm up tables.

Embodiment 6. The method of embodiment 1, 2, 3, 4, and/or 5, wherein the first tensor stores execution times for different combinations of one or more workloads of one or more types.

Embodiment 7. The method of embodiment 1, 2, 3, 4, 5, and/or 6, wherein the second tensor stores standard deviations for the one or more workloads of one or more types.

Embodiment 8. The method of embodiment 1, 2, 3, 4, 5, 6, and/or 7, further comprising, during training, selecting an action and executing the action in a state;

Embodiment 9. The method of embodiment 1, 2, 3, 4, 5. 6. 7. and/or 8, further comprising generating the rewards prior to termination of the workloads.

Embodiment 10. The method of embodiment 1, 2, 3, 4, 5, 6, 7, 8, and/or 9, further comprising observing the new state, computing a loss and updating the states.

Embodiment 11. A system, comprising hardware and/or software, operable to perform any of the operations, methods, or processes, or any portion of any of these, or any combination thereof disclosed herein.

Embodiment 12. A non-transitory storage medium having stored therein instructions that are executable by one or more hardware processors to perform operations comprising the operations of any one or more of embodiments 1-11.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, engine, agent, or client may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

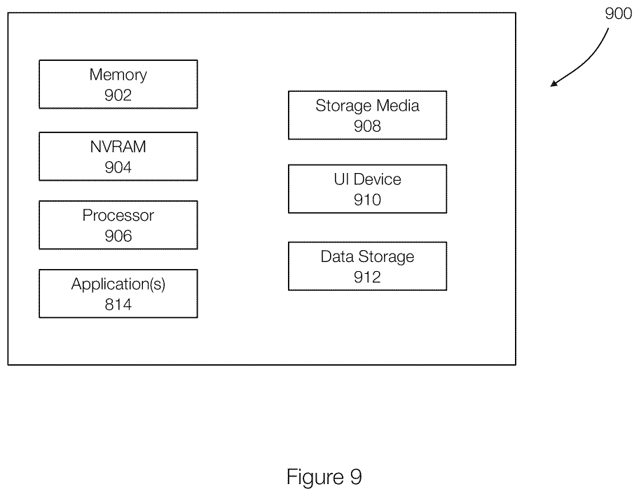

With reference briefly now to FIG. 9, any one or more of the entities disclosed, or implied by the Figures and/or elsewhere herein, may take the form of, or include, or be implemented on, or hosted by, a physical computing device, one example of which is denoted at 900. As well, where any of the aforementioned elements comprise or consist of a virtual machine (VM), that VM may constitute a virtualization of any combination of the physical components disclosed in FIG. 9.

In the example of FIG. 9, the physical computing device 900 includes a memory 902 which may include one, some, or all, of random access memory (RAM), non-volatile memory (NVM) 904 such as NVRAM for example, read-only memory (ROM), and persistent memory, one or more hardware processors 906, non-transitory storage media 908, UI device 910, and data storage 912. One or more of the memory components 902 of the physical computing device 900 may take the form of solid state device (SSD) storage. As well, one or more applications 914 may be provided that comprise instructions executable by one or more hardware processors 906 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
generating warm up tables that include probability distributions for time required to execute workload at nodes in a computing environment; and
training a reinforcement learning model using the warm up tables, wherein execution times required to determine rewards for actions performed in the computing environment are determined from the warm up tables.

2. The method of claim 1, further comprising generating execution times for workloads prior to training the reinforcement learning.

3. The method of claim 2, further comprising generating execution times for different types of workloads.

4. The method of claim 1, further comprising generating execution times for one or more workloads of one or more workload types.

5. The method of claim 4, further comprising generating a first tensor and a second tensor for each of the warm up tables.

6. The method of claim 5, wherein the first tensor stores execution times for different combinations of one or more workloads of one or more types.

7. The method of claim 6, wherein the second tensor stores standard deviations for the one or more workloads of one or more types.

8. The method of claim 1, further comprising, during training, selecting an action and executing the action in a state.

9. The method of claim 8, further comprising generating the rewards prior to termination of the workloads.

10. The method of claim 9, further comprising observing the new state, computing a loss and updating the states.

11. A non-transitory storage medium having stored therein instructions that are executable by one or more hardware processors to perform operations comprising:
generating warm up tables that include probability distributions for time required to execute workload at nodes in a computing environment; and
training a reinforcement learning model using the warm up tables, wherein execution times required to determine rewards for actions performed in the computing environment are determined from the warm up tables.

12. The non-transitory storage medium of claim 11, further comprising generating execution times for workloads prior to training the reinforcement learning.

13. The non-transitory storage medium of claim 12, further comprising generating execution times for different types of workloads.

14. The non-transitory storage medium of claim 11, further comprising generating execution times for one or more workloads of one or more workload types.

15. The non-transitory storage medium of claim 14, further comprising generating a first tensor and a second tensor for each of the warm up tables.

16. The non-transitory storage medium of claim 15, wherein the first tensor stores execution times for different combinations of one or more workloads of one or more types.

17. The non-transitory storage medium of claim 16, wherein the second tensor stores standard deviations for the one or more workloads of one or more types.

18. The non-transitory storage medium of claim 11, further comprising, during training, selecting an action and executing the action in a state.

19. The non-transitory storage medium of claim 18, further comprising generating the rewards prior to termination of the workloads.

20. The non-transitory storage medium of claim 19, further comprising observing the new state, computing a loss and updating the states.
